(19) United States
(12) Patent Application Publication
(10) Pub. No.: US 2008/0228554 A1
(43) Pub. Date: Sep. 18, 2008

(54) System, Method and Apparatus for Determining a Target for Distributing Molding Material Equipment

(75) Inventors: Jeffrey Douglas MACDONALD, Toronto (CA); Adam Craig REYNOLDS, Bolton (CA)

Correspondence Address: HUSKY INJECTION MOLDING SYSTEMS, LTD;CO/AMC INTELLECTUAL PROPERTY GRP, 500 QUEEN ST. SOUTH, BOLTON, ON, L7E 5S5, CA

(73) Assignee: HUSKY INJECTION MOLDING SYSTEMS LTD., Bolton (CA)

(21) Appl. No.: 11/686,698

(22) Filed: Mar. 15, 2007

(51) Int. Cl. G06Q 99/00; G06Q 10/00

(52) U.S. Cl. 705/10; 700/95; 700/96; 705/28; 705/35

(57) ABSTRACT

A method, system and a computing apparatus for determining a target molding material user for distribution of molding material equipment to molding material users from a molding material producer is disclosed. The computing apparatus, for example, includes a processing module operable to receive (i) supply information representative of molding material equipment available for distribution from the molding material producer, and (ii) demand information representative of at least one molding material user in need of molding material equipment, and to determine the target molding material user to which to supply molding material equipment from the molding material producer in accordance with at least the supply information and the demand information.

### FIELD OF THE INVENTION

The present invention relates to molding material equipment in general and, more particularly, to system, method and a computing apparatus for determining a target for distributing molding material equipment.

### BACKGROUND OF THE INVENTION

Various types of molding material equipment can be used to process suitable materials (for example, molding material) in some manner to produce products for consumers or other third parties. A general non-limiting example would be processing polyethylene terepthalate (PET) using injection molding material equipment to output a preform for a beverage container, for example. To generate revenue, molding material equipment manufacturers sell such molding material equipment to, for example, molding material users who use such equipment to process the molding material. The molding material equipment manufacturers can use various advertising and marketing techniques to reach out to such molding material users to sell as much molding material equipment as possible to generate revenue and to build shareholder value. However, advertising and marketing can be inefficient methods of generating new or continued business, for example, by failing to reach as broad customer base as possible. In addition, the limited distribution channels for the molding material equipment, particularly for large molding material equipment, can also limit the market reach of these manufacturers. For example, the equipment manufacturers may not be aware of the equipment needs of customers of the molding material producers with whom the equipment manufacturer may not have contact, thereby losing or failing to leverage such business opportunities.

### SUMMARY OF THE INVENTION

According to a first broad aspect of the present invention, there is provided a system for determining a target molding material user for distribution of molding material equipment from a molding material producer. The system comprises a processing module configured to receive (i) supply information representative of molding material equipment available for distribution from the molding material producer, and (ii) demand information representative of at least one molding material user in need of molding material equipment, and to determine the target molding material user to which to supply molding material equipment from the molding material producer in accordance with at least the supply information and the demand information.

According to a second broad aspect of the present invention, there is provided a method for determining a target molding material user for distribution of molding material equipment from a molding material producer. The method comprises receiving (i) supply information representative of molding material equipment available for distribution from the molding material producer, and (ii) demand information representative of at least one molding material user in need of molding material equipment, and determining the target molding material user to which to supply molding material equipment from the molding material producer in accordance with at least the supply information and the demand information.

According to a third broad aspect of the present invention, there is provided an apparatus for determining a target molding material user for distribution of molding material equipment from a molding material producer. The apparatus comprises means for receiving (i) supply information representative of molding material equipment available for distribution from the molding material producer, and (ii) demand information representative of at least one molding material user in need of molding material equipment, and means for determining the target molding material user to which to supply molding material equipment from the molding material producer in accordance with at least the supply information and the demand information.

According to a fourth broad aspect of the present invention, there is provided a computer-readable medium containing a computer program for determining a target molding material user for distribution of molding material equipment to molders from a molding material producer, wherein the computer program, when executed by a computing apparatus, performs:
receiving (i) supply information representative of molding material equipment available for distribution from the molding material producer, and (ii) demand information representative of at least one molding material user in need of molding material equipment, and
determining the target molding material user to which to supply molding material equipment from the molding material producer in accordance with at least the supply information and the demand information.

According to another broad aspect of the present invention, there is provided a method of distributing molding material equipment. The method comprises purchasing molding material equipment; placing the purchased molding material equipment with a target molding material user; and obtaining an agreement from the target molding material user, wherein the target molding material user agrees to purchase molding material from a same party that placed the purchased molding material equipment with the target molding material user.

According to yet another broad aspect of the present invention, there is provided a method of obtaining molding material equipment. The method comprises receiving molding material equipment from a molding material producer; and agreeing to purchase molding material from the molding material producer in exchange for receipt of the molding material equipment.

According to yet another broad aspect of the present invention, there is provided a system. The system comprises at least one molding material user; a molding material equipment manufacturer; a molding material producer operable to supply molding material; the molding material producer being further operable to receive (i) supply information representative of molding material equipment available for distribution from the molding material producer, and (ii) demand information representative of a given one of the at least one molding material user being in need of molding material equipment, and to determine a target molding material user to which to supply molding material equipment from the molding material producer in accordance with at least the supply information and the demand information. The molding material producer being further operable to purchase molding material equipment from the molding material equipment manufacturer and to place the purchased molding material equipment with the target molding material user in exchange for an agreement from the target molding material user to purchase molding material from the molding material producer.

### BRIEF DESCRIPTION OF THE DRAWINGS

Objects and advantages of the present invention will become apparent to those skilled in the art upon reading the following detailed description of non-limiting embodiments of the present invention, in conjunction with the accompanying drawings, wherein like reference numerals have been used to designate like elements, and wherein:

FIG. 1 is a block diagram illustrating a system for determining a target for distribution of molding material equipment to molding material users from a molding material producer, in accordance with a non-limiting embodiment of the present invention.

FIG. 2 is a flowchart illustrating steps of a method for determining a target for distribution of molding material equipment to molding material users from a molding material producer, in accordance with a non-limiting embodiment of the present invention.

FIG. 3 is a flowchart illustrating steps of a method for distributing molding material equipment, in accordance with an alternative non-limiting embodiment of the present invention.

FIG. 4 is a flowchart illustrating steps of a method for obtaining molding material equipment, in accordance with an alternative non-limiting embodiment of the present invention.

### DETAILED DESCRIPTION OF EMBODIMENTS

Non-limiting embodiments of the present invention are directed to a system, method and apparatus for determining a target molding material user for delivering molding material equipment from a molding material producer. Generally speaking, a molding material equipment manufacturer produces molding material equipment for processing molding material. A molding material producer supplies molding material to a molding material user, which can use molding material equipment to process molding material. The molding material producer can be an entity that produces the molding material or an entity that brokers/distributed the molding material producer from the entity that has produced the molding material. According to embodiments of the present invention, the molding material producer determines a target molding material user to which to distribute molding material equipment. Then, the molding material producer (rather than the molding material equipment manufacturer) distributes the molding material equipment to the target molding material user. In such a manner, a technical effect can be achieved, whereby additional distribution channels for the molding material equipment can be opened on behalf of the molding material equipment manufacturing by the molding material producer. Another technical effect may be achieved whereby a given molding material user may gain access to additional and/or new molding material equipment from the molding material producer that they may not have gained access to otherwise (i.e. if they had to purchase the new and/or additional molding material equipment from the molding material equipment manufacturer or supplier).

In various non-limiting embodiments of the present invention, the molding material equipment can be molding material equipment (ex. injection molding material equipment, etc.), auxiliary equipment for a molding system (such as, but not limited to, a resin dryer, a mold chiller, a dehumidifier, a part coating system, a part handling system and the like), an extrusion molding system, auxiliary equipment for the extrusion molding system, or the like. The molding material equipment manufacturer can be a manufacturer of injection molding material equipment, auxiliary equipment for an injection molding system or extrusion molding systems, etc. The molding material can be a resin, a metal alloy or the like, and the molding material producer can be a resin producer, a metal alloy producer and the like. The molding material producer can also be a molding material broker or another intermediary. The molding material users can be customers of the resin or metal alloy producer who use the resin or metal alloy products manufactured by the resin or metal alloy producer. The molding material users also require molding material equipment to process the molding material, such as the resin or metal alloy.

Using an example of the molding material producer being a resin producer and the molding material equipment being injection molding material equipment manufactured by the injection molding material equipment manufacturer, the resin producer can determine a target customer who to distribute the injection molding material equipment to. The resin producer can then distribute the injection molding material equipment to the target customer of the resin producer on behalf of the injection molding material equipment manufacturer. More specifically, the resin producer can purchase the injection molding material equipment from the injection molding material equipment manufacturer and to provide the injection molding material equipment to a the target customer (as determined by various embodiments of the present invention), for example, in exchange for a commitment from the target customer to purchase the resin from the resin producer. In such a manner, a technical effect can be achieved, whereby additional and/or alternative distribution channels can be opened to and leveraged by the injection molding material equipment manufacturers, whereby additional injection molding material equipment can be distributed to resin users by the resin producers rather than by the injection molding material equipment manufacturers themselves.

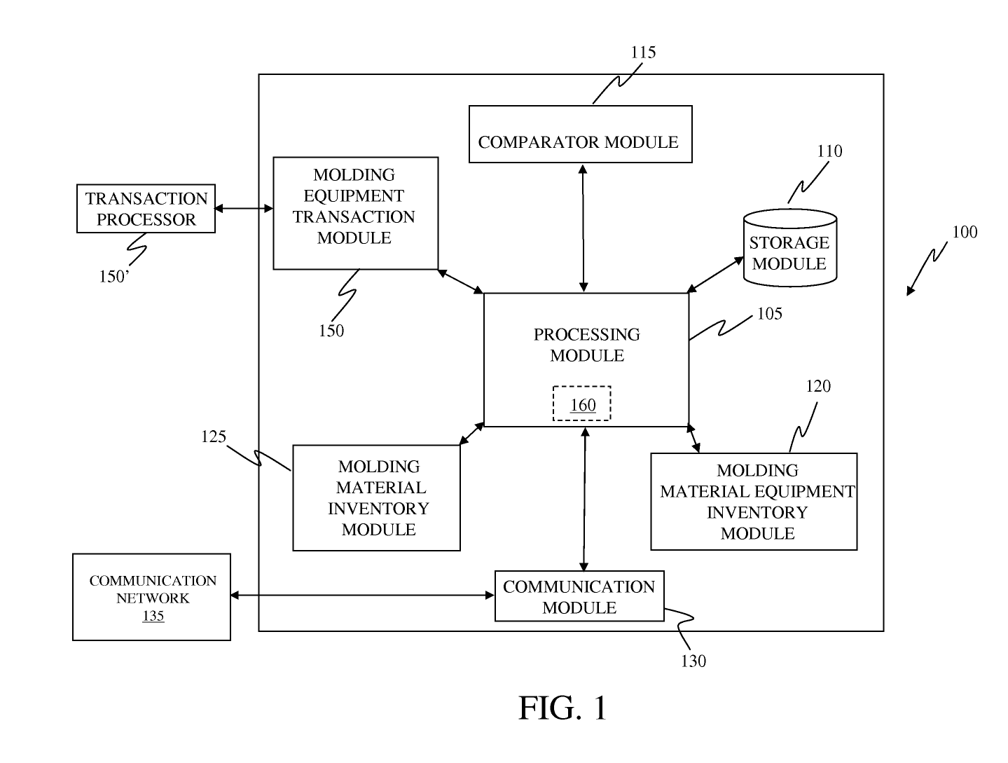

These and other aspects and embodiments of the present invention will now be described in greater detail. FIG. 1 is a block diagram illustrating a system 100 for determining a target for distribution of molding material equipment to molding material users from a molding material producer, in accordance with a non-limiting embodiment of the present invention. As used herein, the “molding material” can be any fungible material or commodity that can be manufactured or otherwise processed using suitable molding material equipment, such as, for example, resin, steel, aluminum or the like. For purposes of illustration and not limitation, the molding material can comprise, for example, a resin or other molding material, and the molding material producer can be a resin or other molding material producer. Consequently, the molding material equipment can be suitable type of equipment or other appropriate machinery that is capable of processing such a material or commodity to produce molded articles. Continuing with the present illustration, the molding material equipment can be, for example, injection molding material equipment or the like that is produced by an injection molding material equipment manufacturer or supplier, and the molding material users can be users of the resin or other molding material who operate the injection molding material equipment to process the resin or other molding material. According to a non-limiting embodiment, the molding material users are customers of the molding material producer. Continuing with the present illustration, the resin users are customers of the resin producer, and these customers use the injection molding material equipment to process the resin. However, those of ordinary skill in the art will recognize that the system 100 described herein can be implemented in a wide variety of situations where there are molding material producers, molding materials and concomitant users of such materials, and molding material equipment that is used by such users to process such materials.

The system 100 comprises a processing module 105. In some embodiments of the present invention, the processing module 105 can comprise a computing apparatus, such as a general-purpose or a specific-purpose computer, a laptop, a desktop, a tablet computer, a Personal Digital Assistant and the like. The system 100 can further include a storage module 110. In the specific non-limiting embodiment depicted with reference to FIG. 1, the storage module 110 is communicatively coupled to the processing module 105. However, in alternative non-limiting embodiments of the present invention, the storage module 110 can be internal to the processing module 105. The storage module 110 can comprise any suitable type of computer-readable or other computer storage medium capable of storing information in electrical, electronic, or digital form.

The storage module 110 is configured to maintain supply information. The supply information can be representative of molding material equipment available for distribution from the molding material producer. According to a non-limiting embodiment, the supply information can include, for example, an inventory of molding material equipment available at the molding material producer. Additionally or alternatively, the supply information can include, for example, an inventory of molding material equipment available from a molding material equipment manufacturer or supplier. In an alternative non-limiting embodiment of the present invention, the supply information can include, for example, an indication of molding material equipment that can be manufactured by a given molding material equipment manufacturer upon receipt of an order from the molding material producer.

The storage module 110 is also configured to maintain demand information. The demand information can be representative of at least one molding material user in need of molding material equipment. According to a non-limiting embodiment, the demand information can include, for example, a listing or other suitable information of molding material users having an insufficient inventory of molding material equipment. Such an insufficient inventory can include zero molding material equipment or some number of molding material equipment that is below what is needed by the molding material user to effectively process or otherwise use the molding material. Additionally or alternatively, the demand information can include, for example, a listing or other suitable information of molding material users having outdated (e.g., aging) inventory of molding material equipment for which replacement equipment is needed.

The storage module 110 can maintain a plethora of additional and/or alternative data, such as, but not limited to (i) data representative of currently available molding material equipment at a given molding material user; (ii) data representative of how long a given piece of molding material equipment at a given molding material user has been in use for, (iii) etc.

In some embodiments of the present invention, the processing module 105 receives the demand information associated with a given molding material user from the given material user and populates the demand information into the storage module 110. Within these non-limiting embodiments of the present invention, the given molding material user can submit an indication to the molding material producer that the given molding material user is in need of new or additional molding material equipment. Such an indication can be submitted, for example, via a telephone, an electronic message, a fax transmission, by filling in and mailing a request form, etc.

In an alternative non-limiting embodiment of the present invention, the processing module 105 can determine the demand information associated with the given molding material user. Within these embodiments of the present invention, the storage module 110 can be configured to maintain molding material inventory information. In a first example of implementation of this embodiment, the molding material inventory information can be associated with a given molding material user. In other words, the molding material inventory information can be representative of the current stock of the molding material available at or to the given molding material user. How molding material inventory information associated with the given molding material user is obtained and/or populated will be explained in greater detail herein below. In a second example of implementation of this embodiment, the molding material inventory information can be associated with the molding material producer. In other words, the molding material inventory information can be representative of the current stock of the molding material available for distribution from the molding material producer, for example, to the given molding material user.

The system 100 can further comprise a comparator module 115 internal to or in communication with the processing module 105. The processing module 105 can be configured to determine the demand information associated with the given molding material user. For example, the processing module 105 can instruct or otherwise cause the comparator module 115 to determine whether there is an excess amount of molding material either (i) at the given molding material user that can not be currently processed by the available molding material equipment of the given molding material user or (ii) available at the molding material producer for distribution to the given molding material user. In other words, a given molding material user can be said to require (or have demand for) additional molding material equipment when either (i) the given molding material user has excess molding material or (ii) the molding material producer has excess molding material that can be sold to the molding material user; and the molding material user does not currently have the capacity (i.e. the required number of molding material equipment) to process the excess molding material.

For the avoidance of doubt, it should be expressly understood that the term “excess molding material available at the molding material producer for distribution to the given molding material user” can mean either: (i) molding material physically available at the molding material producer (i.e. molding material that has already been produced by the molding material producer and is ready for distribution), or (ii) molding material that the molding material producer has a capacity to produce (i.e. molding material that has not yet been produced per se, but that can be produced under certain conditions, for example, when there is a need for distributing the excess molding material to a given molding material user).

According to one non-limiting embodiment, the comparator module 115 can include or have access to appropriate look-up tables (not depicted) that can map molding material levels to various predetermined thresholds. Such look-up tables can be stored in a suitable computer memory or other computer storage device internal to or in communication with the processing module 105. For example, such tables can be stored at the above-mentioned storage module 110. For purposes of illustration and not limitation, if the amount of molding material in inventory is between zero and M units (M being any suitable number greater than zero), then the look-up table can indicate that there is a low-level of inventory. If the amount of molding material in inventory is between M and N units (N being any suitable number greater than M), then the look-up table can indicate that there is a suitable inventory (e.g., enough inventory of the molding material to meet expected demand). Finally, if the amount of molding material in inventory is greater than N units, then the look-up table can indicate that there is excess inventory.

Alternatively, suitable Boolean or other logic or rules can be used to determine whether there is an excess amount of molding material. For example, continuing with the present illustration, Boolean logic can be used to determine that IF the amount of molding material in inventory is greater than N units, THEN there is an excess amount of molding material. Likewise, Boolean logic can be used to determine that IF the amount of molding material in inventory is less than N units, THEN there is a low-level of molding material. Finally, Boolean logic can be used to determine that IF the amount of molding material in inventory is between M and N units (N being any suitable number greater than M), THEN there is a suitable inventory (e.g., enough inventory of the molding material to meet expected demand). The complexity of such logic or rules will depend on the nature and type of molding material, as well as other like factors. More complex mechanisms, such as neural networks, can be adapted to “learn” how to respond to such inventory information. For example, according to a non-limiting embodiment, the processing module 105 can “learn” that an inventory of greater than N units constitutes excess inventory. Such information can be fed back to the processing module 105 to allow such “learning” to take place and to refine these or other inventory determination algorithms.

For purposes of illustration and not limitation, the comparator module 115 can determine that there is N-M excess units of molding material available at the given molding material user or available for distribution to the given molding material user. Consider the following non-limiting example that is used for illustration purposes only. The comparator module 115 can retrieve from the storage module 110 information indicative of the fact that the given molding material user has, for example, four of the five pieces of molding material equipment needed for processing the molding material. Assume for purposes of the present illustration that each piece of molding material equipment is capable of processing the N-M excess units of resin. Based on such information, the comparator module 115 can compare the N-M excess units with the one piece of equipment needed by the molding material user. Accordingly, the comparator module 115 can generate molding material equipment comparison information that with the one extra piece of equipment the molding material user can handle or otherwise use the extra N-M units of resin (as each piece of equipment can handle N-M units of resin). The comparator module 115 can then transmit the molding material equipment comparison information to the processing module 105, which can populate the demand information within the storage module 110 based on the molding material equipment comparison information. Continuing with this specific example, the demand information associated with the given molding material user stored within the storage module 110 is indicative of the given molding material user can be potentially interested in additional molding material equipment, as there either (i) exists the excess molding material inventory at the given molding material user (ii) exists the excess molding material inventory at the molding material producer available for distribution to the molding material user.

Irrespective of how the demand information is populated, based on such demand information associated with a given molding material user, the processing module 105 can determine that the given molding material user is a potential target (or candidate) for distribution of molding material equipment from the molding material producer. The processing module 105 can further retrieve the supply information from the storage module 110 in order to determine whether there exists in stock (or available from the molding material equipment manufacturer or supplier) a molding material equipment that can satisfy the demand of the given molding material equipment user. If such molding material equipment does exist in stock at either the molding material producer or the molding material equipment manufacturer (or supplier), the processing module 105 determines that the given molding material user is a target for distributing the molding material equipment to. Accordingly, it can be that the processing module 105 determines a target (i.e. a molding material user, which can be a molder) for distribution of the molding material equipment based on at least the demand and supply information maintained within the storage module 110.

Once the processing module 105 determines the target molding material user for distributing the molding material equipment, the processing module 105 can output information representative of the target molding material user, for example on a screen (not depicted) coupled to the processing module 105 or a printer (not depicted) coupled to the processing module 105. Considering a specific non-limiting embodiment of the present invention, where the system 100 is managed and controlled by a molding material producer, a representative of the molding material producer can use the outputted information to approach a representative of the target molding material user to negotiate supply of new or additional molding material equipment.

In some embodiments of the present invention, the processing module 105 can comprise a customer relationship management module 160. It should be expressly understood that the customer relationship management module 160 is optional and, as such, can me omitted in other alternative non-limiting embodiments of the present invention. It should be further understood, that even though the customer relationship management module 160 is depicted as an internal element to the processing module 105, in an alternative non-limiting embodiment of the present invention, the customer relationship management module 160 can be arranged in communication with or otherwise coupled to the processing module 105. In yet further non-limiting embodiments of the present invention, the customer relationship management module 160 can be internal to or in communication with another component of the system 100, such as, for example, the comparator module 115.

The customer relationship management module 160 can be configured to implement various routines, for example, at least some of: (a) rating an opportunity associated with a given target molding material user; (b) determine a new opportunity (such as, for example, a growth opportunity or a new market opportunity) and the like. For example, the processing module 105 can determine that there exists a first molding material user and a second molding material user to which to supply the molding material equipment. The customer relationship management module 160 can, for example, rate an opportunity associated with the first molding material user and the second molding material user. For example, the customer relationship management module 160 can rate the opportunity based on a respective credit rating of the first and second molding material users, market segments served by the first and second molding material users, etc. In an alternative non-limiting embodiment of the present invention, the processing module 105 may determine that there exists excess molding material available for distribution from the molding material producer to a given molding material user. The customer relationship management module 160 can determine whether the given molding material user would be able to purchase the excess molding material (even if the given molding material user is supplied with the molding material equipment by the molding material producer at no cost to the molding material user other than the cost associated with purchasing the excess molding material, or part thereof, from the molding material producer). The customer relationship management module 160 can perform the determination by, for example, performing or obtaining a credit rating associated with the given molding material user, etc.

The customer relationship management module 160 can also determine a growth opportunity, for example, based on a market opportunity for the given molding material user. For example, if a given molding material user is likely to introduce a new product to the market, the customer relationship management module 160 can determine new or additional molding material equipment that is likely to be required by the molding material user to deliver the new product. The customer relationship management module 160 can update the demand information associated with the given molding material user stored in the storage module 110. Naturally, the customer relationship management module 160 can implement a number of additional routines to make a number of additional determinations.

In an alternative non-limiting embodiment of the present invention, the processing module 105 can determine demand information associated with a given molding material user, when some or all of the equipment of the given molding material user is out-of-date or about to become out-of-date. It should be recalled that the storage module 110 can store data representative of how long a given piece of molding material equipment at a given molding material user has been in use for. The processing module 105 (or the comparator module 115) can further maintain tables (not depicted) that can map an age of a piece of molding material equipment and the likelihood of the molding material user who uses that piece of molding material equipment upgrading to the new molding material equipment. For example, it may be that after 5 years a given molding material user is likely to upgrade, after 7 years—very likely to upgrade and after 10 years —certain to upgrade. Naturally, any other suitable benchmarks and thresholds can be used. Accordingly, the processing module 105 can determine the demand information associated with the given molding material user based on likelihood of the given molding material user upgrading to the new molding material equipment.

The system 100 can also include a molding material equipment inventory module 120 internal or in communication with the processing module 105. The molding material equipment inventory module 120 is configured to manage molding material equipment inventory information at the molding material producer. In a non-limiting embodiment, the molding material equipment inventory module 120 is configured to update the supply information of molding material equipment available for distribution at the molding material producer. For example, when the molding material equipment comprises injection molding material equipment, the inventory information can comprise some or all of (i) the numbers of injection molding machines on hand, (ii) the models of the machines, (iii) the number of drops (e.g., nozzles) that each machine contains, and other similar inventory information. In some embodiments of the present invention, the functionality of the molding material equipment inventory module 120 can be incorporated into the functionality of the customer relationship management module 160.

The molding material equipment inventory module 120 can be configured to keep track of molding material equipment available at the molding material producer and to populate/update the supply information stored at the storage module 110 accordingly. In an alternative non-limiting embodiment, the molding material equipment inventory module 120 can be configured to request and/or receive information representative of molding material equipment available at the molding material equipment manufacturer or supplier and to populate/update the supply information stored at the storage module 110 accordingly.

The system 100 can further comprise a molding material inventory module 125 internal or in communication with the processing module 105. The molding material inventory module 125 is configured to manage molding material inventory information. It should be recalled that the molding material inventory information can be representative of (i) the molding material inventory available for distribution from the molding material producer; and/or (ii) the molding material inventory available at or to a given molding material user.

In those embodiments of the present invention, where the molding material inventory information is representative of the molding material inventory available for distribution from the molding material producer, the molding material inventory module 125 can keep track of the molding material available at the molding material producer and can update the molding material inventory information stored at the storage module 110 accordingly. For this purposes, the molding material inventory module 125 can be integrated with or in communication with an inventory system (not depicted) associated with the molding material producer. Alternatively, the molding material inventory module 125 can be part of the inventory system associated with the molding material producer and vice versa.

In those embodiments of the present invention, where the molding material inventory information is representative of the molding material inventory available at or to the given molding material user, the molding material inventory module 125 can become aware of the molding material inventory information associated with the given molding material user by virtue of the molding material inventory module 125 being managed by the molding material producer and the given molding material user being a customer of the molding material producer. Accordingly, the molding material inventory module 125 can keep track of the molding material supplied to the given molding material user by the molding material producer. In an alternative non-limiting embodiment, the molding material inventory module 125 can become aware of the molding material inventory information associated with the given molding material user by virtue of the given molding material user providing such molding material inventory information to the molding material producer who manages and controls the system 100. The molding material inventory information can be provided, for example, via a telephone, an electronic message, a fax transmission, by filling in and mailing a form, etc.

The system 100 can further comprise a communication module 130 in communication with or otherwise coupled to the processing module 105. According to a non-limiting embodiment, the communication module 130 can be configured to communicate information with entities external to the system 100. For example, the communication module 130 can be configured to communicate some or all of: (i) molding material equipment inventory information with molding material equipment manufacturers and/or suppliers; (ii) molding material inventory information with molding material users; (iii) data representative of currently available molding material equipment at a given molding material user; (iv) data representative of how long a given molding material equipment at a given molding material user has been used for. In some embodiments of the present invention, the communication module 130 can be configured to communication with other entities, such as, but not limited to, the aforementioned inventory system (not depicted) associated with the molding material producer. Naturally, the communication module 130 can be configured to transmit a plethora of other types of information (e.g., information from remote databases, systems, storage facilities or the like for obtaining information for use by or supplying information generated from the system 100). The communication module 130 can be embodied in at least a portion of at least (a) a modem, (b) a fax machine, (c) an input terminal for inputting information received in a printed form, (d) a scanner, (e) a router, (f) a wireless access point and the like.

The communication module 130 is capable of communicating appropriate information to and from the system 100 via, for example, a communication network 135. The type of the communication network 135 is not particularly limited and, as such, the communication network 135 can comprise a portion of one or more of the public switched telephone network (PSTN), a Local Area Network (ex. an intranet), a Wide Area Network (such as, for example, the Internet or World Wide Web), a wireless communication network, a dedicated communication link or the like.

The system 100 can further comprise a molding material equipment transaction module 150 internal or in communication with the processing module 105. The molding material equipment transaction module 150 can be configured to conduct a financial transaction for distributing the molding material equipment from the molding material producer to the molding material user. The molding material equipment transaction module 150 can be any suitable type of financial transaction/settlement module that is capable of processing, routing, and settling fund or other financial transactions according to non-limiting embodiments of the present invention. For purposes of illustration and not limitation, the molding material equipment transaction module 150 can comprise a transaction network (not depicted) such as, for example, the MasterCard or Visa networks, or any other suitable type of financial network that is capable of processing such financial transactions regionally and/or internationally. The molding material equipment transaction module 150 can comprise or can also be in communication with a transaction processor 150′. The transaction processor 150′ can be configured to perform suitable financial processing (e.g., crediting or debiting financial accounts, performing electronic fund transfers, and the like) on the molding material equipment transactions involving the purchase and sale of molding material equipment by molding material equipment users from the molding material producers. Likewise, the transaction processor 150′ can be configured to perform suitable financial processing (e.g., crediting or debiting financial accounts, performing electronic fund transfers, and the like) on the molding material transactions involving the purchase and sale of molding material by the molding material producers from the molding material equipment manufacturers and provision of the molding material equipment to molding material users.

In an alternative non-limiting embodiment of the present invention, the molding material equipment transaction module 150, the transaction processor 150′ or a portion thereof can be in communication with each other via a portion of the communication network 135. As will be appreciated by those of skill in the art, within these embodiments of the present invention, the molding material equipment transaction module 150 and the transaction processor 150′ can implement a shared security protocol for secure exchange of information therebetween.

According to a non-limiting embodiment, the transaction processor 150′ can comprise or otherwise be associated with an appropriate financial institution (e.g., a bank, originating depository financial institution (ODFI), or the like) or other suitable organization or entity that is capable of processing such fund transactions. The transaction network is configured to select or otherwise “point to” the transaction processor 150′ (e.g., by storing the network, computer, Internet Protocol (IP), or other identifying address of the transaction processor 150′) for processing the financial transactions. The transaction processor 150′ can perform such processing in any suitable manner. For example, the transaction processor 150′ can be comprised of suitable algorithms, Boolean or other logic functions or rules, neural networks, and/or forms of artificial intelligence that are capable of learning information about a fund transaction and, based on that information, process that molding material equipment transaction (and/or molding material transaction) appropriately.

Those of ordinary skill in the art will recognize that each of the modules of the system 100 can be located locally to or remotely from each other, while use of the system 100 as a whole still occurs at any given location of any given module of the system 100, such as, for example, within a given country (e.g. the United States). For example, merely for purposes of illustration and not limitation, the storage module 110, the comparator module 115, the molding material equipment inventory module 120, the molding material inventory module 125, the communication module 130, the molding material equipment transaction module 150, or any combination of such modules, can be located extraterritorially to the United States (e.g., in Canada and/or in one or more other foreign countries). However, the processing module 105 can be located within the United States, such that the control of the system 100, as a whole, is exercised and beneficial use of the system 100 is obtained by the user within the United States. Those skilled in the art will appreciate that the storage module 110, the comparator module 115, the molding material equipment inventory module 120, the molding material inventory module 125, the communication module 130, the molding material equipment transaction module 150 and the processing module 105 can have any other suitable geographical arrangement.

Even though various components of the system 100 (such as, for example, the comparator module 115, the storage module 110, the molding material equipment inventory module 120, the molding material inventory module 125, the communication module 130, the molding material equipment transaction module 150, etc.) are coupled to each other via the processing module 105 (i.e. a hub-type architecture), in alternative non-limiting embodiments of the present invention, components of the system 100 can be arranged in other types of arrangements, such as a mesh network, via a local network (not depicted), etc.

In some embodiments of the present invention, the system 100 as a whole (including all of its components) can be controlled and managed by a single entity, such as for example, a molding material producer, a third party providing functionality of the system 100 to a number of molding material producers, a molding material equipment supplier and the like. In alternative non-limiting embodiments, some of the components of the system 100 can be controlled and managed by a first entity, while others of the components of the system 100 can be controlled and managed by a second entity.

Each of modules of the system 100, including the processing module 105, the storage module 110, the comparator module 115, the molding material equipment inventory module 120, the molding material inventory module 125, the communication module 130, and the molding material equipment transaction module 150, or any combination of such modules, can be comprised of any suitable type of electrical or electronic component or device that is capable of performing the functions associated with the respective module. According to such non-limiting embodiment, each component or device can be in communication with another component or device using any appropriate type of electrical connection that is capable of carrying (e.g., electrical) information. For example, each of the modules of the system 100 can be comprised of any combination of hardware, firmware and software that is capable of performing the functions associated with the respective module.

The system 100 may include of one or more microprocessors and associated memory(ies) that store the steps of a computer program to perform the functions of any or all of the modules of the system 100. The microprocessor can be any suitable type of processor, such as, for example, any type of general purpose microprocessor or microcontroller, a digital signal processing (DSP) processor, an application-specific integrated circuit (ASIC), a programmable read-only memory (PROM), an erasable programmable read-only memory (EPROM), an electrically-erasable programmable read-only memory (EEPROM), a computer-readable medium, or the like. The memory can be any suitable type of computer memory or any other type of electronic storage medium, such as, for example, read-only memory (ROM), random access memory (RAM), cache memory, compact disc read-only memory (CDROM), electro-optical memory, magneto-optical memory, or the like. As will be appreciated based on the foregoing description, the memory can be programmed using conventional techniques known to those having ordinary skill in the art of computer programming to perform the functions of any or all of the modules of the system 100. For example, the actual source code or object code of the computer program can be stored in the memory.

Alternative architectures or structures can be used to implement the various functions of the system 100 as described herein. For example, functions from two or more modules can be implemented in a single module, or functions from one module can be distributed among several different modules. Additionally, the architecture of system 100 depicted and described with respect to FIG. 1 has been chosen to best illustrate the overall functionality of the claimed invention. Splitting the functionality into a processing module, a comparator module, a storage module, a molding material equipment inventory module, a molding material inventory module, a communication module and a molding material equipment transaction module was done for ease of discussion. Physically, these components do not have to be separate and distinct components/subsystems with the functionalities assigned to each as described herein. It will be apparent to a person of ordinary skill in the relevant art how to implement alternative physical architectures comprising fewer or more subsystems which together perform the functionality described herein. For example, in an alternative non-limiting embodiment of the present invention functionality of the system 100 can be embodied in a single computing apparatus.

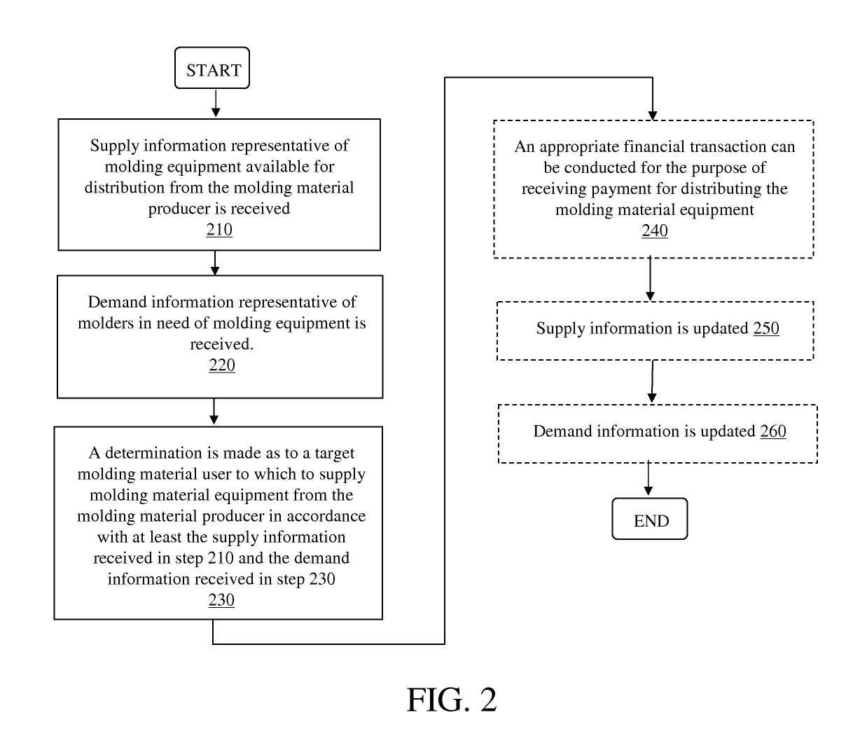

FIG. 2 is a flowchart illustrating a method for determining a target molding material user for distribution of molding material equipment from a molding material producer, in accordance with a non-limiting embodiment of the present invention. In an embodiment of the present invention, the method of FIG. 2 can be executed by the system 100 of FIG. 1. For the purposes of execution of the method of FIG. 2 it shall be assumed that the storage module 110 has been populated with at least one instance of supply information representative of molding material equipment available for distribution from the molding material producer and at least one instance demand information of molding material users in need of molding material equipment. However, if such information is not populated and as will be appreciated by one of skill in the art, the method of FIG. 2 can include two additional steps 202 and 204 executed prior to step 210, the steps 202 and 204 being substantially similar to the steps 250 and 260 described in detail herein below.

### Step 210

In step 210, the supply information representative of molding material equipment available for distribution from the molding material producer is received. More specifically, the processing module 105 accesses the storage module 110 and retrieves the supply information stored therein. It should be recalled that the molding material equipment can comprise, for example, injection molding material equipment or the like.

### Step 220

In step 220, demand information representative of molders in need of molding material equipment is received. More specifically, the processing module 105 accesses the storage module 110 and retrieves the demand information stored therein. It should be recalled that the demand information can include, for example, a listing of molding material users having an insufficient inventory of molding material equipment. Additionally or alternatively, the demand information can include, for example, a listing of molding material users having outdated inventory of molding material equipment.

### Step 230

In step 230, a determination is made as to a target molding material user to which to supply molding material equipment from the molding material producer in accordance with at least the supply information received in step 210 and the demand information received in step 220. In some embodiments of the present invention, as part of step 230, the processing module 105 instructs or otherwise causes the comparator module 115 to determine the target molding material user to which to supply molding material equipment.

### Step 240

In step 240, an appropriate financial transaction can be conducted for the purpose of transmitting a payment for distributing the molding material equipment. For example, the processing module 105 can instruct or otherwise cause the molding material equipment transaction module 150 to transmit a payment to the molding material equipment manufacturer (or supplier) associated with purchase of a given piece of the molding material equipment for delivery of such given piece of the molding material equipment to the target molding material user. Upon successful completion of the financial transaction, the molding material equipment is distributed from the molding material producer to the molding material user. Naturally, in case that the target molding material user rejects to accept the molding material equipment, step 240 can be omitted.

In some embodiments of the present invention, the method of FIG. 2 can include a number of additional optional steps.

### Optional Step 250

In step 250, supply information is updated. More specifically, the processing module 105 instructs or otherwise causes the molding material equipment inventory module 120 to determine whether new and/or updated supply information is available. In those non-limiting embodiment, where the supply information comprises an indication of the molding material equipment available for distribution at the molding material producer, the molding material equipment inventory module 120 can determine whether there have been any changes in the number of molding material equipment available at the molding material producer. In those non-limiting embodiment, where the supply information comprises an indication of molding material equipment available from the molding material equipment manufacturer, the molding material equipment inventory module 120 requests or otherwise receives information representative of molding material equipment available at the molding material equipment manufacturer or suppliers, for example by exchanging suitable messages via the communication module 130 and the communication network 135.

### Optional Step 260

In step 260, demand information is updated. How the step 260 is implemented will naturally depend on what the molding material inventory information is representative of.

In those embodiments, where the molding material inventory information is representative of the molding material inventory available at the molding material producer, step 260 can be executed as follows. The processing module 105 instructs or otherwise causes the molding material inventory module 125 to determine whether there have been any changes in the molding material inventory available at the molding material producer.

In those embodiments, where the molding material inventory information is representative of the molding material inventory available at a given molding material user, step 260 can be executed as follows. The processing module 105 instructs or otherwise causes the molding material inventory module 125 whether there have been any changes in the molding material inventory available at or to one or more molding material users. In those embodiments of the present invention, where the system 100 is managed by the molding material producer, the molding material inventory module 125 can determine whether there have been any changes in the molding material inventory of one or more molding material users. In those embodiments where the system 100 is managed by a third party, the molding material inventory module 125 communication suitable messages (for example, via the communication module 130) to check with molding material producers or molding material users whether there have been any changes in the molding material inventory of one or more molding material users.

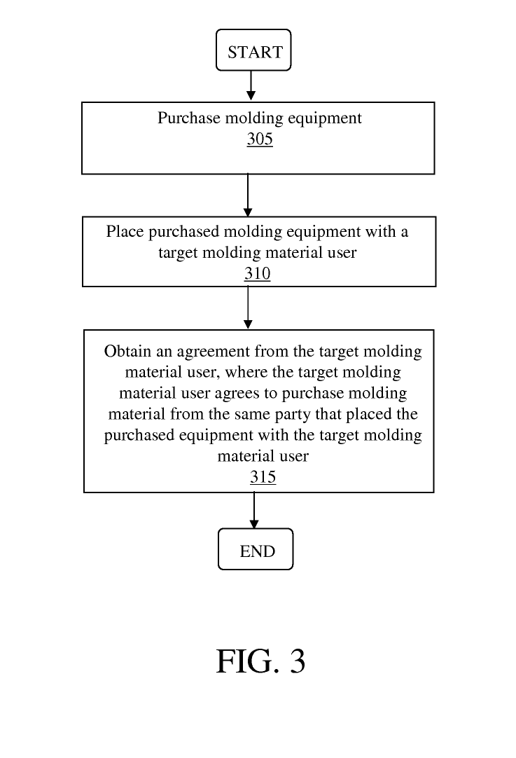

FIG. 3 is a flowchart illustrating a method for distributing molding material equipment from a molding material producer, in accordance with an alternative non-limiting embodiment of the present invention.

### Step 305

In step 305, molding material equipment is purchased. According to a non-limiting embodiment, the molding material equipment can be purchased, for example, by the molding material producer. It should be recalled that the molding material producer may include an entity that actually produces the molding material or an entity that distributes the molding material, such as, for example, a molding material broker.

### Step 310

In step 310, the purchased molding material equipment is placed with a target molding material user. The target molding material user may be, for example, a target molder in need of additional molding material equipment.

### Step 315

In step 315, an agreement is obtained from the target molding material user, wherein the target molding material user agrees to purchase molding material from the same party that placed the purchased equipment with the molder (e.g., molding material producer). In some embodiments of the present invention, the agreement may be to purchase a given amount of molding material from the same party that placed the purchased equipment with the target molding material user. In an alternative non-limiting embodiment, the agreement may be to purchase the molding material exclusively from the same party that placed the purchased equipment with the target molding material user.

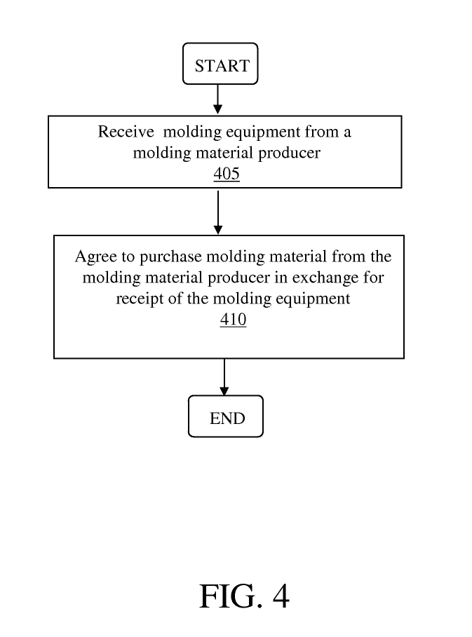

FIG. 4 is a flowchart illustrating a method for obtaining molding material equipment from a molding material producer, in accordance with an alternative non-limiting embodiment of the present invention.

### Step 405

In step 405, the molding material equipment is received from a molding material producer. In a non-limiting embodiment, the party that receives the molding material equipment comprises a target molding material user, such as, for example, a molder.

### Step 410

In step 410, there is an agreement to purchase molding material from the molding material producer in exchange for receipt of the molding material equipment. In some embodiments of the present invention, the agreement may be to purchase a given amount of molding material from the same party that placed the purchased equipment with the target molding material user. In an alternative non-limiting embodiment, the agreement may be to purchase the molding material exclusively from the same party that placed the purchased equipment with the target molding material user.

Each, all or any combination of the steps of a computer program as illustrated in FIGS. 2-4 can be embodied in any computer-readable medium for use by or in connection with an instruction execution system, apparatus, or device, such as a computer-based system, processor-containing system, or other system that can fetch the instructions from the instruction execution system, apparatus, or device and execute the instructions. As used herein, a “computer-readable medium” can be any means that can contain, store, communicate, propagate, or transport the program for use by or in connection with the instruction execution system, apparatus, or device. The computer readable medium can be, for example but not limited to, an electronic, magnetic, optical, electromagnetic, infrared, or semiconductor system, apparatus, device, or propagation medium. More specific examples (a non-exhaustive list) of the computer-readable medium can include the following: an electrical connection having one or more wires, a portable computer diskette, a random access memory (RAM), a read-only memory (ROM), an erasable programmable read-only memory (EPROM or Flash memory), an optical fiber, and a portable compact disc read-only memory (CDROM).

Even though the foregoing description has described the methods of FIG. 2, FIG. 3 and FIG. 4 using the system 100 of FIG. 1, one skilled in the art will appreciate that in an alternative non-limiting embodiment of the present invention, the methods of FIG. 2, FIG. 3 and FIG. 4 can be implemented, at least in part, using an alternative non-limiting embodiment of the system 100 that can be implemented, at least in part, in a non-automated fashion. The system 100 and their modules may be implemented using one or more tool or process that may require manual management and/or manipulation of information. The tools and processes for the manual management and/or manipulation of information may include non-computer or non-electrical means (e.g. mental faculty, paper-based ledger, manually manipulated computer ledger/spreadsheet, etc.).

For example, in an alternative non-limiting embodiment of the system 100 of FIG. 1, a system (not depicted) for determining distribution of molding material equipment to molders from a molding material producer can include a first processing module (not depicted). Within this non-limiting embodiment of the present invention, the first processing module may include a first ledger for manual-management, at least in part, of the supply information representative of molding material equipment available for distribution from the molding material producer. The system can further include a second processing module (not depicted). Within this non-limiting embodiment of the present invention, the second processing module may include a second ledger for manual-management, at least in part, of the demand information representative of molding material users in need of molding material equipment. The system can also configured to determine target molding material users to which to supply molding material equipment from the molding material producer in accordance with at least the demand and supply information. The step of determining which molding material users to supply molding material equipment from the molding material producer in accordance with the supply and demand information may be performed by a person, or persons, having regard to the information contained in the first and second ledgers. Preferably, at least one of the first and the second ledger further includes a rule-set (empirical or non-empirically derived) that may be referenced by the person(s) in making the determination in view of the information in the first and second ledger.

Non-limiting embodiments of the present invention can be used in conjunction with any device, system or process for determining distribution of molding material equipment to molding material users from a molding material producer. Non-limiting embodiments can provide users of the present invention with cost-savings and increased operational efficiencies by effectively leveraging additional distribution channels for such equipment. For example, non-limiting embodiments of the present invention can be used by injection molding material equipment manufacturers to increase distribution channels by having resin producers, who are customers of the injection molding material equipment manufacturer, distribute such machinery to customers of the resin producer.

It will be appreciated by those of ordinary skill in the art that the present invention can be embodied in various specific forms without departing from the spirit or essential characteristics thereof. The presently disclosed embodiments are considered in all respects to be illustrative and not restrictive. The scope of the invention is indicated by the appended claims, rather than the foregoing description, and all changes that come within the meaning and range of equivalence thereof are intended to be embraced.

All United States patents and applications, foreign patents and applications, and publications discussed above are hereby incorporated by reference herein in their entireties.

What is claimed is:

1. A system for determining a target molding material user for distribution of molding material equipment from a molding material producer, the system comprising:
a processing module configured:
to receive (i) supply information representative of molding material equipment available for distribution from the molding material producer, and (ii) demand information representative of at least one molding material user in need of molding material equipment, and
to determine the target molding material user to which to supply molding material equipment from the molding material producer in accordance with at least the supply information and the demand information.

2. The system of claim 1, wherein the system further comprises a comparator module coupled to the processing module, the comparator module being operable to determine the demand information.

3. The system of claim 1, wherein the comparator module is operable to determine the demand information based on molding material inventory information.

4. The system of claim 3, further comprising a molding material inventory module coupled to the processing module, the molding material inventory module being operable to manage the molding material inventory information.

5. The system of claim 4, wherein to manage the molding material inventory information, the molding material inventory module is operable to update the molding material inventory information stored in a storage module coupled to the processing module.

6. The system of claim 5, further comprising the storage module.

7. The system of claim 3, wherein the molding material inventory information is representative of molding material inventory available at the molding material producer.

8. The system of claim 3, wherein the molding material inventory information is representative of molding material inventory available at or to a given molding material user.

9. The system of claim 3, wherein to determine the demand information, the comparator module is operable to determine excess molding material inventory information based on the molding material inventory information.

10. The system of claim 9, wherein the comparator module is further operable to render molding material equipment comparison information associated with a given molding material user if the given molding material user is associated with excess molding material.

11. The system of claim 10, wherein the comparator module is further operable to determine, based on the supply information, whether there exists molding material equipment that can process the excess molding material associated with the given molding material user and wherein the comparator module is further operable to indicate to the processing module that the given molding material user is the target molding material user, if there exists molding material equipment that can process the excess molding material.

12. The system of claim 11, wherein the processing module is further operable to output an indication of the target molding material user.

13. The system of claim 12, wherein the processing module is operable to output the indication of the target molding material user by means of at least one of a screen and a printer coupled to the processing module.

14. The system of claim 1, further comprising a customer relationship management module coupled to the processing module, the customer relationship management module being operable to rate the target molding material user.

15. The system of claim 14, the target molding material user comprising a first target molding material user and a second target molding material user, wherein the customer relationship management module is operable to access a first opportunity associated with the first target molding material user and a second opportunity associated with the second target molding material user by analyzing their respective credit ratings.

16. The system of claim 14, wherein the customer relationship management module is further operable to determine a growth opportunity associated with a given molding material user and to update the demand information based on the growth opportunity.

17. The system of claim 1, further comprising a molding material equipment inventory module coupled to the processing module, the molding material equipment inventory module being operable to manage molding material equipment inventory information to derive the supply information.

18. The system of claim 17, wherein to manage the molding material equipment inventory, the molding material equipment inventory module is operable to determine molding material equipment inventory associated with the molding material producer.

19. The system of claim 17, wherein to manage the molding material equipment inventory, the molding material equipment inventory module is operable to determine molding material equipment inventory associated with at least on of a molding material equipment manufacturer and a molding material equipment supplier.

20. The system of claim 1, wherein the demand information comprises a listing of molders having an insufficient inventory of molding material equipment.

21. The system of claim 1, wherein the demand information comprises a listing of molders having outdated inventory of molding material equipment.

22. The system of claim 1, wherein the supply information comprises an inventory of molding material equipment available at the molding material producer.

23. The system of claim 1, wherein the supply information comprises an inventory of molding material equipment available from at least one of (i) a molding material equipment manufacturer and (ii) a molding material equipment supplier.

24. The system of claim 1, further comprising a molding material equipment transaction module coupled to the processing module, the molding material equipment transaction module being configured to conduct a financial transaction for distributing the molding material equipment from the molding material producer to the target molding material user.

25. The system of claim 1, wherein the molding material equipment comprises injection molding material equipment.

26. The system of claim 1, wherein the molding material equipment comprises auxiliary equipment for a molding system.

27. The system of claim 1, wherein the auxiliary equipment comprises at least on of a resin dryer, a mold chiller, a dehumidifier, a part coating system, a part handling system and a combination thereof.

28. The system of claim 1, wherein the molding material comprises a resin.

29. The system of claim 1, wherein the molding material comprises a metal alloy.

30. The system of claim 1, further comprising a storage module coupled to the processing module, the storage module configured to store the supply information and the demand information.

31. The system of claim 1, further comprising a communication module coupled to the processing module.

32. The system of claim 31, wherein the communication module is further coupled to a communication network.

33. A method for determining a target molding material user for distribution of molding material equipment from a molding material producer, the method comprising:
receiving (i) supply information representative of molding material equipment available for distribution from the molding material producer, and (ii) demand information representative of at least one molding material user in need of molding material equipment, and
determining the target molding material user to which to supply molding material equipment from the molding material producer in accordance with at least the supply information and the demand information.

34. The method of claim 33, further comprising determining the demand information.

35. The method of claim 33, wherein the determining the demand information comprises determining the demand information based on molding material inventory information.

36. The method of claim 35, further comprising managing the molding material inventory information.

37. The method of claim 36, wherein the managing comprises updating the molding material inventory information stored in a storage module.

38. The method of claim 35, wherein the molding material inventory information is representative of molding material inventory available at the molding material producer.

39. The method of claim 35, wherein the molding material inventory information is representative of molding material inventory available at or to a given molding material user.

40. The method of claim 35, wherein the determining the demand information comprises determining excess molding material inventory information based on the molding material inventory information.

41. The method of claim 40, further comprising rendering molding material equipment comparison information associated with a given molding material user, if the given molding material user is associated with excess molding material.

42. The method of claim 41, further comprises (i) determining, based on the supply information, whether there exists molding material equipment that can process the excess molding material associated with the given molding material user and (ii) indicating that the given molding material user is the target molding material user, if there exists molding material equipment that can process the excess molding material.

43. The method of claim 42, further comprising outputting an indication of the target molding material user.

44. The method of claim 43, wherein the outputting comprises outputting the indication of the target molding material user by means of at least one of a screen and a printer.

45. The method of claim 33, further comprising rating the target molding material user.

46. The method of claim 45, the target molding material user comprising a first target molding material user and a second target molding material user, wherein the rating comprises accessing a first opportunity associated with the first target molding material user and a second opportunity associated with the second target molding material user by analyzing their respective credit ratings.

47. The method of claim 45, further comprising determining a new opportunity associated with a given molding material user and updating the demand information based on the new opportunity.

48. The method of claim 33, further comprising managing molding material equipment inventory information to derive the supply information.

49. The method of claim 48, the managing comprises determining molding material equipment inventory associated with the molding material producer.

50. The method of claim 49, wherein the managing comprises determining molding material equipment inventory associated with at least on of a molding material equipment manufacturer and a molding material equipment supplier.

51. The method of claim 33, wherein the demand information comprises a listing of molders having an insufficient inventory of molding material equipment.

52. The method of claim 33, wherein the demand information comprises a listing of molders having outdated inventory of molding material equipment.

53. The method of claim 33, wherein the supply information comprises an inventory of molding material equipment available at the molding material producer.

54. The method of claim 33, wherein the supply information comprises an inventory of molding material equipment available from at least one of (i) a molding material equipment manufacturer and (ii) a molding material equipment supplier.

55. The method of claim 33, further comprising a molding material equipment transaction module coupled to the processing module, the molding material equipment transaction module being configured to conduct a financial transaction for distributing the molding material equipment from the molding material producer to the target molding material user.

56. The method of claim 33, wherein the molding material equipment comprises injection molding material equipment.

57. The method of claim 33, wherein the molding material equipment comprises auxiliary equipment for a molding system.

58. The method of claim 33, wherein the auxiliary equipment comprises at least on of a resin dryer, a mold chiller, a dehumidifier, a part coating system, a part handling system and a combination thereof.

59. The method of claim 33, wherein the molding material comprises a resin.

60. The method of claim 33, wherein the molding material comprises a metal alloy.

61. The method of claim 33, further comprising a storage module coupled to the processing module, the storage module configured to store the supply information and the demand information.

62. The method of claim 33, further comprising a communication module coupled to the processing module.

63. The method of claim 62, wherein the communication module is further coupled to a communication network.

64. An apparatus for determining a target molding material user for distribution of molding material equipment from a molding material producer, the apparatus comprising:
means for receiving (i) supply information representative of molding material equipment available for distribution from the molding material producer, and (ii) demand information representative of at least one molding material user in need of molding material equipment, and
means for determining the target molding material user to which to supply molding material equipment from the molding material producer in accordance with at least the supply information and the demand information.

65. A computer-readable medium containing a computer program for determining a target molding material user for distribution of molding material equipment to molders from a molding material producer, wherein the computer program, when executed by a computing apparatus, performs:
receiving (i) supply information representative of molding material equipment available for distribution from the molding material producer, and (ii) demand information representative of at least one molding material user in need of molding material equipment, and
determining the target molding material user to which to supply molding material equipment from the molding material producer in accordance with at least the supply information and the demand information.

66. A method of distributing molding material equipment comprising:
purchasing molding material equipment;
placing the purchased molding material equipment with a target molding material user; and
obtaining an agreement from the target molding material user, wherein the target molding material user agrees to purchase molding material from a same party that placed the purchased molding material equipment with the target molding material user.

67. The method of claim 66, further comprising determining the target molding material user with which to place the purchased molding material equipment.

68. The method of claim 66, wherein the same party comprises a molding material producer.

69. The method of claim 66, wherein the molding material equipment comprises an injection molding system.

70. The method of claim 66, wherein the molding material equipment comprises auxiliary equipment for a molding system.

71. The method of claim 66, wherein the molding material comprises a resin.

72. The method of claim 66, wherein the molding material comprises a metal alloy.

73. The method of claim 66, wherein the molding material equipment comprises an extrusion molding system.

74. The method of claim 66, wherein the obtaining an agreement comprises obtaining an agreement from the target molding material user to purchase molding material exclusively from the same party that placed the purchased molding material equipment with the target molding material user.

75. The method of claim 66, wherein the obtaining an agreement comprises obtaining an agreement from the target molding material user to purchase a given amount of molding material from the same party that placed the purchased molding material equipment with the target molding material user.

76. A method of obtaining molding material equipment, comprising:
receiving molding material equipment from a molding material producer; and
agreeing to purchase molding material from the molding material producer in exchange for receipt of the molding material equipment.

77. The method of claim 76, wherein the molding material equipment comprises an injection molding system.

78. The method of claim 76, wherein the molding material equipment comprises auxiliary equipment for a molding system.

79. The method of claim 76, wherein the molding material comprises a resin.

80. The method of claim 76, wherein the molding material comprises a metal alloy.

81. The method of claim 76, wherein the agreeing to purchase molding material comprises agreeing to purchase molding material exclusively from the molding material producer.

82. The method of claim 76, wherein the agreeing to purchase molding material comprises agreeing to purchase a given amount of the molding material from the molding material producer.

83. A system comprising:
at least one molding material user;
a molding material equipment manufacturer;
a molding material producer operable to supply molding material; the molding material producer being further operable:
to receive (i) supply information representative of molding material equipment available for distribution from the molding material producer, and (ii) demand information representative of a given one of the at least one molding material user being in need of molding material equipment, and
to determine a target molding material user to which to supply molding material equipment from the molding material producer in accordance with at least the supply information and the demand information;
the molding material producer being further operable to purchase molding material equipment from the molding material equipment manufacturer and to place the purchased molding material equipment with the target molding material user in exchange for an agreement from the target molding material user to purchase molding material exclusively from the molding material producer.
